(19) United States
(12) Patent Application Publication
(10) Pub. No.: US 2004/0219310 A1
(43) Pub. Date: Nov. 4, 2004

(54) Ink-jet recording medium

(75) Inventors: Yasuhiro Ogata, Shizuoka-ken (JP); Hiroshi Yamamoto, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/830,044

(22) Filed: Apr. 23, 2004

(30) Foreign Application Priority Data
May 1, 2003 (JP) 2003-126393

(51) Int. Cl. B41M 5/00

(52) U.S. Cl. 428/32.24

(57) ABSTRACT

The present invention provides an ink-jet recording medium including a support having disposed thereon at least one colorant-receiving layer, wherein an undercoat layer containing an inorganic laminar compound with an aspect ratio of 100 or more is provided under the colorant-receiving layer, and/or a back-coat layer containing an inorganic laminar compound with an aspect ratio of 100 or more is provided on a surface opposite to a surface of the support having the colorant-receiving layer.

### CROSS-REFERENCE TO RELATED APPLICATION

This application claims priority under 35 USC 119 from Japanese Patent Application No. 2003-126393, the disclosure of which is incorporated by reference herein.

### BACKGROUND OF THE INVENTION

1. Field of the Invention

The present invention relates to an ink-jet recording medium, particularly to an ink-jet recording medium in which cracks and curls are suppressed from being generated.

2. Description of the Related Art

With rapid progress of the information technology (IT) industry in recent years, various information processing systems have been developed. Recording methods and recording devices suitable for these information processing systems have also been developed and put to practical use in many fields.

An ink-jet recording method has become widely used not only for office-use, but also for home-use since the ink-jet recording method enables recording to be performed on various recording materials, the hardware (device) is relatively inexpensive and compact, and operation is quiet.

Moreover, with higher resolution of ink-jet printers in recent years, it is also possible to obtain a photorealistic high quality printed material. Progress made in such hardware (devices) has also led to various kinds of ink-jet recording sheets being developed.

Characteristics usually required for such ink-jet recording sheets are (1) rapid drying property (high ink-absorbing rate), (2) appropriate and uniform diameter of ink-dots (no blur), (3) proper particle diameter and distribution, (4) high circularity of dots, (5) high color density, (6) high color saturation (not dimmed), (7) water resistance, light fastness and ozone resistance of printed images, (8) high degree of whiteness of the recording sheet, (9) good storability of the recording sheet (no yellowish color change with long-term preservation), (10) hard to deform with good dimensional stability (degree of curling is small enough), and (11) good running ability on the hardware.

In addition to the characteristics described above, glossy photographic paper sheets used for obtaining the so-called photorealistic high quality printed materials are required to have surface lubricity, glossiness, and feeling of the printing paper similar to silver salt photographs.

In response to such demands, an ink-jet recording paper comprising a laminar pigment and a binder having a specified glass transition temperature (Tg) on the back face thereof has been proposed for controlling surface roughness caused by ink absorption during the recording process (refer to, for example, Japanese Patent Application Laid-Open (JP-A) No. 4-298380). However, such paper cannot exhibit a curl suppressing effect in a broad temperature range and a crack suppressing effect on a surface of an ink-image receiving layer.

While an ink-jet recording sheet containing a tabular inorganic pigment with an aspect ratio (the ratio of average particle diameter/thickness) in the range of 5 to 90 on a back-coat layer has been proposed (refer to, for example, JP-A No. 5-221115), such a sheet also cannot exhibit a curl suppressing effect in a broad temperature and humidity range and a crack suppressing effect on the surface of an ink-image receiving layer.

Meanwhile, a support of a recording material provided with a layer comprising a swellable laminar inorganic compound on a surface of a base paper and coated with a resin has been proposed for improving surface lubricity and rigidity (refer to, for example, JP-A No. 11-38553). However, it is desirable to suppress formation of cracks on the surface of the recording layer while the recording sheet is also suppressed from curling in a broad temperature range.

### SUMMARY OF THE INVENTION

It is an object of the present invention to solve the above problems by providing an ink-jet recording medium capable of high image quality recording by suppressing curling of recording sheets in a broad temperature and humidity range, by suppressing a surface of a colorant-receiving layer from cracking, and by suppressing irregular printing from being generated.

The invention provides an ink-jet recording medium which comprises a support having disposed thereon at least one colorant-receiving layer, wherein an undercoat layer containing an inorganic laminar compound having an aspect ratio of 100 or more is provided under the colorant-receiving layer, and/or a back-coat layer containing an inorganic laminar compound having an aspect ratio of 100 or more is provided on a surface opposite to a surface of the support having the colorant-receiving layer.

### DETAILED DESCRIPTION OF THE INVENTION

An ink-jet recording medium of the present invention is the ink-jet recording medium comprising a support having disposed thereon at least one colorant-receiving layer, wherein an undercoat layer containing an inorganic laminar compound having an aspect ratio of 100 or more is provided under the colorant-receiving layer, and/or a back-coat layer containing an inorganic laminar compound having an aspect ratio of 100 or more is provided on a surface opposite to a surface of the support having the colorant-receiving layer.

When the ink-jet recording medium of the invention has two colorant-receiving layers, the undercoat layer containing the inorganic laminar compound having the aspect ratio of 100 or more may be formed at least at one of the colorant-receiving layers provided on both sides.

Preferably, the ink-jet recording medium of the invention comprises the back-coat layer containing the inorganic laminar compound with the aspect ratio of 100 or more at least on the surface opposite to the surface of the support having the colorant-receiving layer.

The ink-jet recording medium of the invention will be described in detail hereinafter.

Back-Coat Layer

The back-coat layer preferably provided in the ink-jet recording medium of the invention comprises at least the inorganic laminar compound having the aspect ratio of 100 or more, and further a water-soluble resin is preferably contained therein as a binder.

In a low humidity/high humidity environment, a lot of moisture tends to be discharged or absorbed as water vapor in the layer is in contact with the air. Thus, the sheet tends to curl toward one side when a balance between expansion and contraction on both surfaces of the support is disturbed. However, transfer of water in the layer resulting from humidity changes in the air is blocked by permitting the back-coat layer to contain the inorganic laminar compound, and the balance between expansion and contraction on both surfaces of the support can sufficiently be maintained. Since the inorganic laminar compound has strong resistance against a force acting in a planar direction, the compound suppresses a deformation force acting on either the top or the back surfaces to thereby reduce curling of the sheet.

The inorganic laminar compound with the aspect ratio of 100 or more is strong against external force and affords dimensional stability. Consequently, the compound serves to suppress curling in a broad temperature and humidity range and suppressing cracks from forming on the surface of the colorant-receiving layer to thereby enable recording of high quality images.

The aspect ratio of the inorganic laminar compound is preferably 150 or more, and more preferably 200 or more. The aspect ratio is defined as the length of the major axis of the laminar compound divided by the thickness thereof.

Inorganic Laminar Compound

Examples of the inorganic laminar compound include a mica group represented by the following formula (1), talc represented by 3MgO·4SiO₂·H₂O, taeniolite, montmorillonite, saponite, hectorite and zirconium phosphate:

A(B,C)₂₋₃D₄O₁₀(OH, F, 0)₂ (1)

wherein, in formula (1), A represents K, Na or Ca; B and C each independently represent Fe(II), Fe(III), Mn, Al, Mg or V; and D represents Si or Al.

Among the mica group represented by formula (1), examples of natural mica include muscovite, paragonite, phlogopite, biotite and lepidolite; and examples of synthetic mica include non-swellable mica such as fluorine phlogopite KMg₃(AlSi₃O₁₀)F₂, potassium tetrasilicon mica (KMg_{2.5}(Si₄O₁₀)F₂, and swellable mica such as sodium tetrasilicic mica NaMg_{2.5}(Si₄O₁₀)F₂, Na or Li taeniolite (Na, Li)Mg₂Li(Si₄O₁₀)F₂, and Na or Li hectolite (Na, Li)_{1/3}Mg_{2/3}Li_{1/3}(Si₄O₁₀)F₂ belonging to the montmorillonite group. Synthetic smectite is also useful.

Water-swellable synthetic mica is preferable among the laminar compounds in the invention, and water-swellable fluorine-type synthetic mica is particularly preferable.

In the ink-jet recording medium of the invention, the back-coat layer preferably contains the inorganic laminar compound with an aspect ratio of 100 or more in combination with a water-soluble resin, and the inorganic laminar compound is more preferably water-swellable synthetic mica.

This is because (1) while the water-soluble resin readily causes curling by expansion and contraction due to absorption and discharge of water, curling can be suppressed by using the inorganic laminar compound together, and (2) since water-swellable synthetic resin swelled with water is readily cleaved by applying a shear force, laminar fine particles having an aspect ratio of 100 or more can be stably dispersed.

Inclusion of the inorganic laminar compound with an aspect ratio of 100 or more in the back-coat layer not only increases the elastic modulus and strength of the layer, but also the in-plane thermal expansion coefficient and molding contract ratio are reduced and the layer become isotropic. Consequently, it is believed that this prevents the sheet from being curled.

The average major axis length of the particles of the inorganic laminar compound having an aspect ratio of 100 or more is preferably 0.3 to 20 μm, more preferably 0.5 to 10 μm, and particularly preferably 1 to 5 μm.

The average thickness of the laminar compound is preferably 0.1 μm or less, more preferably 0.05 μm or less, and particularly preferable 0.01 μm or less.

A ratio (x/y by mass) of the content (x) of the inorganic laminar compound to the content (y) of the water-soluble resin in the back-coat layer is preferably in the range of 1/100 to 100/100.

When the ratio of x/y is less than 1/100, or when the proportion of the laminar compound is too small, the expansion/contraction balance between the top and bottom surfaces of the ink-jet recording medium cannot be maintained, and curling cannot sufficiently be prevented. On the other hand, when the ratio exceeds 100/100, or when the amount of the laminar compound is too large, the back-coat layer may be cracked or powders may be peeled off from the layer.

The proportion of the laminar compound preferably falls within the above range even when several kinds of the inorganic laminar compounds are used.

Examples of the water-soluble resin include those resins having a hydroxyl group as a hydrophilic structural unit such as polyvinyl alcohol-type resins (e.g., polyvinyl alcohol (PVA), acetoacetyl-modified polyvinyl alcohol, cation-modified polyvinyl alcohol, anion-modified polyvinyl alcohol, silanol-modified polyvinyl alcohol and polyvinyl acetal), cellulose-type resins (e.g., methyl cellulose (MC), ethyl cellulose (EC), hydroxyethyl cellulose (HEC), carboxymethyl cellulose (CMC), hydroxypropyl cellulose (HPC), hydroxyethylmethyl cellulose and hydroxypropylmethyl cellulose), chitin, chitosan, starch, ether bond-containing resins (e.g., polyethylene oxide (PEO), polypropylene oxide (PPO), polyethylene glycol (PEG), and polyvinylether (PVE)), and carbamoyl group-containing resins (e.g.,polyacrylamide (PAAM), polyvinylpyrrolidone (PVP) and polyacrylic acid hydrazide). Among these resins, polyvinyl alcohol-type resins, cellulose-type resins, ether bond-containing resins, carbamoyl group-containing resins, carboxyl group-containing resins and gelatins are preferable.

Plyacrylate salts having carboxylic groups as dissociating groups, maleic acid resins, alginic acid salts and gelatins are also included in the preferable resins.

The polyvinyl alcohol resins and gelatins are preferable among the resins described above. Examples of the polyvinyl alcohol resins are described in Japanese Patent Application Publication (JP-B) Nos. 4-52786, 5-67432, 7-29479 and 7-57553; Japanese Patent Nos. 2537827, 2502998, 3053231, 2604367 and 2750433; JP-A Nos. 63-176173, 7-276787, 9-207425, 11-58941, 2000-135858, 2001-205924, 2001-287444, 62-278080, 9-39373, 2000-158801, 2001-213045, 2001-328345, 8-324105 and 11-348417.

Gelatin is produced by usual methods, and examples of such gelatin include known gelatin produced by treating cow bone, cow hide and pig skin with lime and an acid as described in “Glue and Gelatin”, ed. by Yoshihiro Abiko, published by Association of Nihon Glue and Gelatin Industry, 1987. Low molecular weight, low viscosity gelatin described in JP-A No. 11-34495 may be used suitably.

These water-soluble resins may be used alone, or in combination of two or more thereof. The content of the water-soluble resin is preferably 1 to 40% by mass, more preferably 2 to 33% by mass, relative to the mass of a total solid content of the colorant-receiving layer.

The coating amount of the water-soluble resin in the back-coat layer of the invention is preferably 0.2 to 10 g/m², since this range affords preferable curling characteristics.

The back-coat layer of the invention may contain a pigment, metal soap, wax and waterproof agent in the range not impairing the effects of the invention in view of running ability during the recording process.

While the pigment is not particularly restricted, examples of the pigment include kaolin, sintered kaolin, talc, agalmatolite, diatomaceous earth, calcium carbonate, aluminum hydroxide, magnesium hydroxide, zinc oxide, lithopone, amorphous silica, colloidal silica, sintered gypsum, silica, magnesium carbonate, titanium oxide, alumina, barium carbonate, barium sulfate, mica, micro-balloon, urea-formalin filler, polyester particles, and cellulose filler.

Examples of the metal soap include polyvalent metal salts of higher fatty acids, and specific examples thereof include zinc stearate, aluminum stearate, calcium stearate, and zinc oleate.

The wax preferably has a melting point in the range of 40 to 120° C. Preferable examples of the wax include paraffin wax, polyethylene wax, carnauba wax, microcrystalline wax, candelilla wax, montan wax, and fatty acid amide-type wax. Among them, paraffin wax, montan wax, methylol stearoamide and the like, which have a melting point in the range of 50 to 100° C., are more preferable.

Examples of the waterproof agent include dihydroxy-1,4-dioxane and the derivatives thereof, N-methylol urea, N-methylol melamine, water-soluble initial condensate such as a urea-formalin, dialdehyde compounds such as glyoxal, glutaraldehyde, inorganic cross-linking agents such as boric acid and borax, blend heat treatment products of polyacrylic acid, methylvinyl ether/maleic acid copolymer and isobutylene/maleic anhydride copolymer.

A surfactant may be contained for obtaining a uniform layer when applying the back-coat layer on the support. Examples of the surfactant include alkali metal salts of sulfosuccinic acid and fluorine-containing surfactants. Specific examples include sodium slats and ammonium salts of di-(n-hexyl)sulfosuccinic acid and di-(2-ethylhexyl)sulfosuccinic acid, with anionic surfactants being also suitable.

The thickness of the back-coat layer is preferably 0.2 to 20 μm, and more preferably 0.3 to 15 μm.

Curling of the sheet may not be sufficiently prevented when the thickness is less than 0.2 μm since an expansion/contraction balance cannot be maintained between both surfaces of the ink-jet recording medium; conversely, the sheet may be curled toward the back face side when the thickness exceeds 20 μm.

The back-coat layer can be formed by preparing a coating solution for the back-coat layer and applying the solution on the support through a known method.

Examples of known methods include applications using an air-knife coater, a roll coater, a blade coater, a curtain coater, and a gravure coater.

Undercoat Layer

The ink-jet recording medium of the invention preferably comprises, on the surface opposite to the surface of the support having the colorant-receiving layer, a back-coat layer containing an inorganic laminar compound with an aspect ratio of 100 or more. The recording medium may also comprise an undercoat layer, instead of the back-coat layer, under the colorant-receiving layer, or alternatively, the recording medium may comprise both the back-coat layer and the undercoat layer.

In the invention, another conventionally known undercoating layer may be provided between the support and the above-mentioned undercoat layer.

The undercoat layer contains, similarly to the back-coat layer, the inorganic laminar compound having an aspect ratio of 100 or more. Preferable embodiments thereof are the same as described in the back-coat layer.

Support

The support used in the invention preferably includes a paper substrate, and it is more preferable that the surface of the paper substrate at the side having the colorant-receiving layer exhibits an ink solvent-absorbing property. Time-dependent ink blur can be suitably suppressed when the support includes the paper substrate and the surface of the side having the colorant-receiving layer exhibits an ink solvent-absorbing property.

It is also possible to use, as the support, read-only optical disks such as CD-ROM and DVD-ROM, write-once optical disks such as CD-R and DVD-R, and rewritable optical disks such as CD-RW and CD-RAM, and to dispose the colorant-receiving layer at the labeled surface side.

In the invention, it is required that the surface of the paper substrate is not coated with a resin such as polyolefin, in order to confer the ink solvent-absorbing property on the surface of the paper substrate. An ink solvent can permeate into the inside of the paper substrate, that is, the paper substrate acquires the ink solvent-absorbing property upon addition of the ink solvent dropwise on the surface of the paper substrate when the surface of the support is not coated with the resin such as polyolefin.

The ink solvents as used herein refers to the solvents contained in commercially available dye inks used for aqueous ink-jet printers. The components of the solvent in the ink comprise water and various water-soluble organic solvents. Specific examples thereof include alcohols such as methyl alcohol, isopropyl alcohol, n-butyl alcohol, tert-butyl alcohol and isobutyl alcohol; ketones or ketone alcohols such as acetone and diacetone alcohol; ethers such as tetrahydrofuran and dioxane; polyalkylene glycols such as polyethyleneglycol and polypropyleneglycol; polyvalent alcohols such as glycerin, ethyleneglycol, propyleneglycol, butyleneglycol, triethyleneglycol, diethyleneglycol and triethanolamine; lower alkyl ethers of polyvalent alcohols such as ethyleneglycol methylether, diethyleneglycol methylether, diethyleneglycol ethylether, diethyleneglycol monobutylether and triethyleneglycol monobutylether.

Among these water-soluble organic solvents, mixtures of water and alcohols such as isopropyl alcohol; polyvalent alcohols such as glycerin, ethyleneglycol and diethyleneglycol; and lower alkyl ethers of polyvalent alcohols such as triethyleneglycol monobutylether are preferably used as the component of the ink solvent.

The paper substrate used for the support of the invention preferably contains a kraft pulp obtained from acacia species. Acacia species includes Acacia mangium, Acacia auriculiformis and hybrid acacia, with Acacia mangium being preferable.

Since the kraft pulp made from the acacia species, in particular the kraft pulp made from Acacia mangium, has a high rigidity and tends to curl toward the back face, the effects of the invention to suppress curling in a broad temperature and humidity range as well as cracking on the surface of the colorant-receiving layer are considerably exhibited.

While the paper substrate most preferably comprises 100% of the acacia kraft pulp, other pulps except the acacia kraft pulp may preferably be contained therein. Examples of the material of the pulp other than the acacia kraft pulp include natural pulps obtained from woods selected from needle-leaved trees and broad-leaved trees such as aspen, maple tree, poplar, birch, alder, oak, eucalyptus, pine and hemlock. Aspen and maple are preferable among them.

The paper substrate of the invention preferably comprises 10% by mass or more, and more preferably 20% by mass or more, of the acacia kraft pulp in the pulp constituting the substrate. Lubricity of the support is significantly improved by blending 10% by mass or more of the acacia kraft pulp in the pulp constituting the substrate.

The method for producing the acacia kraft pulp in the invention is not particularly restricted, and the methods for producing usual kraft pulps may be widely used. A specific example of the production method is described below.

The acacia kraft pulp is beaten so that the pulp has water content of 150 to 180%. For determining the water content, a suspension of the beaten pulp is filtered by suction in a filtration vessel called as a centrifugal cup, then the cup containing the pulp is attached to a precipitate tube in a centrifuge, and centrifuged for dewatering for a given time under prescribed conditions. The post-dewatering pulp is taken out and weighed (wet mass; A), and dried at 105° C. and weighed again (dry mass; B). The content of water is represented by the following equation (1):

Water content =[(A−B)/B]×100 (1)

The acacia kraft pulp used in the invention is beaten by means of a beating machine so that the water content calculated by the above-shown equation is 150 to 180%. On the other hand, the pulps other than the acacia kraft pulp are independently prepared, and then mixed with the acacia kraft pulp. Insofar as the water content of the acacia kraft pulp is in the range of 150 to 180%, pulp fibers are sufficiently softened and lubricity of the support is improved, without causing insufficient dewatering of the pulp during a processing on the wire of a paper machine or requiring an increased amount of steam for dying.

If necessary, to the mixed pulp prepared above are added fillers such as clay, talc, calcium carbonate and urea resin fine particles; sizing agents such as rosin, alkylketene dimer, higher fatty acids, epoxydated fatty acid amide, paraffin wax and alkenylsuccinic acid; paper reinforcing agents such as starch, polyamide polyamine epichlorohydrin and polyacrylamide; and fixing agents such as aluminum sulfate and cationic polymers.

The slurry of the pulp prepared as above is formed into a sheet of paper. The paper-producing process comprises a drying step in which an web surface side corresponding to the surface for applying a photographic emulsion on the base paper is pressed against a drum dryer cylinder via a dryer canvas. Tension of the dryer canvas is controlled in the range of 1.5 to 3 kg/cm in this drying step.

Polyvinyl alcohol or a modified product thereof, and/or starch, a brightening agent such as diaminostylbene disulfonic acid, and polyvalent metal chloride such as calcium chloride, magnesium chloride and aluminum salt may be applied on one or both surfaces of the thus dried base paper.

While the thickness of the support is not particularly restricted, the basis weight thereof is desirably 50 to 250 g/m², and more preferably 100 to 200 g/m². Since the ink-jet recording sheet is suitably plane, the surface of the support is also desired to be excellent in planarity and flatness. Accordingly, the surface of the support is preferably surface-treated by applying a heat at 50 to 250° C. and a pressure of 50 to 300 kg/cm² using a machine calender, super calender or soft calender.

Colorant-Receiving Layer

(Water-Soluble Resin)

The colorant-receiving layer of the invention preferably contains a water-soluble resin. Preferable examples of the water-soluble resin include polyvinyl alcohol-type resins containing a hydroxyl group as a hydrophilic structural unit (e.g., polyvinyl alcohol (PVA), and acetoacetyl-modofied polyvinyl alcohol, cation-modified polyvinyl alcohol, anion-modified polyvinyl alcohol, silanol-modified polyvinyl alcohol, and polyvinyl acetal), cellulose-type resins (e.g., methyl cellulose (MC), ethyl cellulose (EC), hydroxyethyl cellulose (HEC), carboxymethyl cellulose (CMC), hydroxypropyl cellulose (HPC), hydroxyethylmethyl cellulose and hydroxypropylmethyl cellulose), chitin, chitosan, starch, resins having ether bonds (e.g., polyethylene oxide (PEO), polypropylene oxide (PPO), polyethyleneglycol (PEG) and polyvinylether (PVE)), resins having carbamoyl groups (e.g., polyacrylamide (PAAM), polyvinylpyrrolidone (PVP) and polyacrylic acid hydrazide). Among these resins, polyvinyl alcohol-type resins, cellulose-type resins, resins having ether bonds, resins having carbamoyl groups, resins having carboxyl groups and gelatin are preferable.

Preferable examples also include polyacrylate salts, maleic acid resins and alginate salts having carboxyl groups as dissociating groups, and gelatin.

The polyvinyl alcohol resins are particularly preferable among the resins described above. Examples of the polyvinyl alcohol resin are described in JP-B Nos. 4-52786, 5-67432, 7-29479 and 7-57553; Japanese Patent Nos. 2537827, 2502998, 3053231, 2604367 and 2750433; JP-A Nos. 63-176173, 7-276787, 9-207425, 11-58941, 2000-135858, 2001-205924, 2001-287444, 62-278080, 9-39373, 2000-158801, 2001-213045, 2001-328345, 8-324105 and 11-348417.

These water-soluble resins may be used alone, or in combination of two or more thereof. The content of the water-soluble resin is preferably 9 to 40% by mass, and more preferably 12 to 33% by mass, relative to a total solid content of the colorant-receiving layer.

The water-soluble resin and fine particles (to be described later) as major components of the colorant-receiving layer of the ink-jet recording medium may each comprise a single material, or mixtures of plural materials.

The kind of the water-soluble resin used in combination with fine particles, particularly silica fine particles, is important for maintaining transparency. The polyvinyl alcohol-type resin is preferable as the water-soluble resin when vapor phase silica is used. The polyvinyl alcohol-type resin having a degree of saponification of 70 to 100% is more preferable, and the polyvinyl alcohol-type resin having a degree of saponification of 80 to 99.5% is particularly preferable.

While the polyvinyl alcohol-type resin has a hydroxyl group in its structural unit, a three dimensional network structure comprising secondary particles of the silica fine particles is readily formed by forming hydrogen bonds between the hydroxyl groups of the resin and silanol groups on the surface of the silica fine particles. A porous colorant-receiving layer having a high void ratio and sufficient strength may be provided by forming the three dimensional network structure.

The porous colorant-receiving layer obtained as above can quickly absorb the ink during ink-jet recording by capillary phenomena, whereby completely circular dots can be formed without generating ink blur.

The polyvinyl alcohol-type resin may be used in combination with other water-soluble resins. The content of the polyvinyl alcohol-type resin is preferably 50% by mass or more, and more preferably 70% by mass or more, in a total of water-soluble resins when the polyvinyl alcohol-type resin is used together with other water-soluble resins.

(Fine Particles)

The colorant-receiving layer in the ink-jet recording medium of the invention preferably contains fine particles. Inclusion of the fine particles in the colorant-receiving layer makes it possible to form a porous structure and thereby enhance an ink-absorbing ability to the layer. If the solid content of the fine particles in the colorant-receiving layer is 50% by mass or higher, and more preferably 60% by mass or higher, a better porous structure can be formed, which enables to provide an ink-jet recording medium having a sufficient ink-absorbing property. Incidentally, the solid content of the fine particles in the colorant-receiving layer is calculated based on the content of the components, excluding water, in the composition constituting the colorant-receiving layer.

In the invention, both organic fine particles and inorganic fine particles may be used as the fine particles.

Preferable examples of organic fine particles include polymer fine particles obtained by emulsion polymerization, micro-emulsion polymerization, soap-free polymerization, seed polymerization, dispersion polymerization, and suspension polymerization. Specific examples of the organic fine particles include polyethylene, polypropylene, polystyrene, polyacrylate, polyamide, silicone resin, phenol resin and natural polymer powders, and latex or emulsion of the polymer fine particles.

Examples of the inorganic fine particles include silica fine particles, colloidal silica, titanium dioxide, barium sulfate, calcium silicate, zeolite, kaolinite, haloysite, mica, talc, calcium carbonate, magnesium carbonate, calcium sulfate, pseudo-boehmite, zinc oxide, zinc hydroxide, alumina, aluminum silicate, calcium silicate, magnesium silicate, zirconium oxide, zirconium hydroxide, cerium oxide, lanthanum oxide and yttrium oxide fine particles. Among them, silica fine particles, colloidal silica, alumina fine particles or pseudo-boehmite fine particles are preferable in order to provide a good porous structure. The fine particles may be used as primary fine particles, or in the form of secondary fine particles formed. The fine particles have an average primary particle diameter of preferably 2 μm or less, and more preferably 200 nm or less.

In the invention, the inorganic fine particles are preferably used so as to exhibit a good ink-absorbing property and image storability. The silica fine particles having an average primary particle diameter of 20 nm or less, colloidal silica having an average primary particle diameter of 30 nm or less, alumina fine particles having an average primary particle diameter of 20 nm or less, and pseudo-boehmite having an average fine pore diameter of 2 to 15 nm are more preferable, with the silica fine particles, alumina fine particles and pseudo-boehmite being particularly preferable.

The silica fine particles are roughly divided into wet-method particles and dry-method (vapor phase method) particles depending on the production methods thereof. Predominantly in the wet-method, active silica is produced by acid decomposition via a silicate salt, followed by causing appropriate polymerization and precipitation thereof to thus obtain hydrated silica. While, predominantly in the dry-method, anhydrous silica is generated by a high temperature vapor phase hydrolysis of halogenated silicon (flame hydrolysis method), and by vaporization through heating reduction of silicate with coke by an arc in an electric furnace followed by air oxidation (arc method). Vapor phase silica refers to anhydrous silica fine particles obtained by the vapor phase method. Vapor phase silica is particularly preferable as the silica fine particles for use in the invention.

While vapor phase silica exhibits different properties from those of hydrated silica depending on the difference in density of the silanol groups on the surface and the presence or absence of voids, vapor phase silica is suitable to provide a three dimensional structure having a high void ratio. In case of the hydrated silica, density of the silanol group at the surface of the fine particles is as high as 5 to 8 groups/nm², and the silica fine particles are liable to be densely aggregated in hydrated silica, while in case of the vapor phase silica, density of the silanol group at the surface of the fine particles is as small as 2 to 3 groups/nm² to thereby form a sparse flocculate in vapor phase silica, although the reason thereof is not clearly understood. From the foregoing, it is presumed that vapor phase silica provides a high void ratio structure.

Since vapor phase silica has a particularly large specific surface area, it exhibits sufficient abilities to absorb and retain the ink. Moreover, the receiving layer can achieve high transparency, high color density and good color developing ability when the fine particles have an appropriate particle diameter distribution owing to low refractive index of the vapor phase silica. Transparency of the receiving layer is important for OHP applications, that require transparency of the sheet, as well as for obtaining high color density and good color developing ability when applying for recording sheets such as glossy photographic paper.

The average primary particle diameter of vapor phase silica is preferably 30 nm or less, more preferably 20 nm or less, particularly 10 nm or less, and most preferably 3 to 10 nm. Since vapor phase silica particles are liable to agglomerate by forming hydrogen bonds through the silanol group, a structure having a large void ratio is formed when the average primary particle diameter is 30 nm or less to effectively improve the ink-absorbing property.

The silica fine particles may be used together with other fine particles. The content of the vapor phase silica in the total fine particles is preferably 30% by mass or more, more preferably 50% by mass or more, when the vapor phased silica fine particles are used together with other fine particles.

Alumina fine particles, hydrated alumina fine particles and a mixture or composite thereof are also preferable as the inorganic fine particles for use in the invention. Hydrated alumina is particularly preferable among them since a sufficient amount of the ink is fixed by being absorbed in alumina. In particular, pseudo-boehmite (Al₂O₃·nH₂O) is preferable. While various types of hydrated alumina may be used, boehmite in the state of a sol is preferably used as the starting material of hydrated alumina such that a smooth layer can readily be obtained.

Pseudo-boehmite has a porous structure with an average pore radius of preferably 1 to 30 nm, and more preferably 2 to 15 nm. The pore volume is preferably 0.3 to 2.0 ml/g, and more preferably 0.5 to 1.5 ml/g. The pore radius and pore volume are measured by a nitrogen adsorption-desorption method using, for example, a gas adsorption-desorption analyzer (for example, trade name: Omnisorp 369, manufactured by Beckman Coulter, Inc.).

Vapor phase alumina fine particles are preferable among various kinds of alumina fine particles, since the particles have a large surface area. Vapor phase alumna has an average primary particle diameter of preferably 30 nm or less, and more preferably 20 nm or less.

The aforementioned fine particles may be preferably used for the ink-jet recording medium according to the embodiments disclosed in,

for example, JP-A Nos. 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777 and 2001-301314.

(Cross-Linking Agent)

The colorant-receiving layer of the ink-jet recording medium of the invention further contains a cross-linking agent, which is capable of cross-linking with the water-soluble resin that is present in the coating layer together with the fine particles. The colorant-receiving layer is preferably a porous layer hardened by a cross-linking reaction effected between the cross-linking agent and the water-soluble resin.

Boron compounds are preferable for causing cross-linking of the water-soluble resin, particularly polyvinyl alcohol resins. Examples of the boron compound include borax, boric acid, borate salts (such as orthoborate, InBO₃, ScBO₃, YBO₃, LaBO₃, Mg₃(BO₃)₂ and CO₃(BO₃)₂), diborate salts (such as Mg₂B₂O₅ and CO₂B₂O₅), metaborate salts (such as LiBO₂, Ca(BO₂)₂, NaBO₂, and KBO₂), tetraborate salts (such as Na₂B₄O₇·10H₂O), and pentaborate salts (such as KB₅O₈·4H₂O, Ca₂B₆O₁₁·7H₂O and CsB50₅). Among them, borax, boric acid and borates are preferable since they are able to promptly cause a cross-linking reaction.

Other compounds than the boron compounds, as described below, can be used for the cross-linking agent of the water-soluble resin.

Examples of such cross-linking agents include aldehyde compounds such as formaldehyde, glyoxal and glutaraldehyde; ketone compounds such as diacetyl and cyclopentanedione; active halogen compounds such as bis(2-chloroethylurea)-2-hydroxy-4,6-dichloro-1,3,5-triazine and 2,4-dichloro-6-S-triazine sodium salt; active vinyl compounds such as divinyl sulfonic acid, 1,3-vinylsulfonyl-2-propanol, N,N′-ethylenebis(vinylsulfonylacetamide) and 1,3,5-triacryloyl-hexahydro-S-triazine; N-methylol compounds such as dimethylolurea and methylol dimethylhydantoin; melamine resin such as methylolmelamine and alkylated methylolmelamine; epoxy resin; isocyanate compounds such as 1,6-hexamethylenediisocyanate; aciridine compounds such as those described in U.S. Pat. Nos. 3,017,280 and 2,983611; carboxyimide compounds such as those described in U.S. Pat. No. 3,100,704; epoxy compounds such as glycerol triglycidyl ether; ethyleneimino compounds such as 1,6-hexamethylene-N,N′-bisethylene urea; halogenated carboxyaldehyde compounds such as mucochloric acid and mucophenoxychloric acid; dioxane compounds such as 2,3-dihydroxydioxane; metal-containing compounds such as titanium lactate, aluminum sulfate, chromium alum, potassium alum, zirconyl acetate and chromium acetate; polyamine compounds such as tetraethylene pentamine; hydrazide compounds such as adipic acid hydrazide; and low molecular compounds or polymers containing at least two oxazoline groups.

These cross-linking agent may be used alone, or in combination of two or more thereof.

Cross-linking is preferably effected by adding the cross-linking agent to an coating solution containing fine particles and the water-soluble resin (hereinafter referred to as “coating solution A”) and/or a basic solution described below, and by applying the basic solution (hereinafter referred to as “coating solution B”) having a pH value of 8 or more onto a coating layer, at either (1) the same time for forming the coating layer by applying coating solution A; or (2) during the drying step of the coating layer formed by applying coating solution A and also before the coating layer exhibits a given falling rate period of drying.

The cross-linking agent, for example, the boron compound is preferably added as follows. When the colorant-receiving layer is formed through curing by causing cross-linking of the coating layer by applying an coating solution (coating solution A) containing the fine particles and the water-soluble resin like polyvinyl alcohol, the layer is cured by cross-linking by applying the basic solution (coating solution B) having a pH value of 8 or more on the coating layer, either (1) at the same time for forming the coating layer by applying coating solution A; or (2) during the drying step of the coating layer formed by applying coating solution A and also before the coating layer exhibits a given falling rate period of drying. The boron compound acting as the cross-linking agent may be contained in either coating solution A or coating solution B, or alternatively may be contained in both the coating solution A and coating solution B.

The use amount of the cross-linking agent is preferably 1 to 50% by mass, and more preferably 5 to 40% by mass, relative to the amount of the water-soluble resin.

(Mordant)

The colorant-receiving layer of the invention preferably contains, as a mordant, at least one compound selected from polyallylamine and the derivatives thereof, and polyvinylamine and the derivatives thereof. These organic mordants may be contained as copolymers with other copolymerizable monomers. The polyallylamine for use in the invention refers to polymerized monoallylamines (including salts thereof.

The organic mordant preferably has a weight average molecular weight of 500 to 100,000 from the view point of preventing time-dependent blur and improving ink absorbing ability of the colorant-receiving layer.

Usable polyallyamine and derivatives thereof include various known arylamine polymers and derivatives thereof. Examples of such derivatives include salts between polyallylamine and acids (examples of the acid include inorganic acids such as hydrochloric acid, sulfuric acid, phosphoric acid and nitric acid, organic acids such as methanesulfonic acid, toluenesulfonic acid, acetic acid, propionic acid, cinnamic acid and (meth)acrylic acid, or combinations thereof and a partial salt of allylamine); derivatives obtained by polymerization of polyallylamine; and copolymers of polyallylamine and other copolymerizable monomers (examples of the monomer include (meth)acrylic acid esters, styrenes, (meth)acrylamides, acrylonitrile and vinyl esters).

While the structure of the polyallylamine derivatives is not particularly restricted, the polymer obtained as above is preferably water-soluble, or soluble in organic solvents miscible with water. However, the polyallylamine derivative may be used in the form of water dispersible latex particles.

Specific examples of polyallylamine and derivatives thereof include those described in JP-B Nos. 62-31722, 2-14364, 63-43402, 63-43403, 63-45721, 63-29881, 1-26362, 2-56365, 2-57084, 4-41686, 6-2780, 6-45649, 6-15592 and 4-68622, Japanese Patent Nos. 3199227 and 3008369, JP-A Nos. 10-330427, 11-21321, 2000-281728, 2001-106736, 62-256801, 7-173286, 7-213897, 9-235318, 9-302026, 11-21321 and 5-140213, WO 99/21901 and WO 99/19372, and Japanese Patent Application National Publication (Laid-Open) No. 11-506488.

Various polyvinylamines and derivatives thereof may be used in the invention. Examples of such derivatives are the same as the polyallylamine derivative described above. Specific examples of the polyvinyl amine and the derivative thereof are the compounds described in JP-A Nos. 5-35162, 5-35163, 5-35164 and 5-88846, 7-118333 and 2000-344990, and Japanese Patent Nos. 2648847 and 2661677.

Polyallylamine and derivatives thereof are preferable among the above listed compounds.

The following mordants may be used together with the foregoing organic mordants in the invention for improving waterproof property and prevention of time-dependent blur of the image formed.

As other mordants, cationic polymers (cationic mordants) as the organic mordant or inorganic mordants are preferable. The mordant contained in the colorant-receiving layer renders the colorant to become stable by an interaction between the mordant and a liquid ink containing an anionic dye as the colorant, to thereby improve waterproof property of the image while preventing time-dependent blur. The organic mordant and inorganic mordant each may be used alone, or the organic mordant and inorganic mordant may be used in combination.

The mordant is included to give a thickness at the portion containing the mordant from the surface of the colorant-receiving layer to account for 10 to 60%, preferably 20 to 40%, of the total thickness of the receiving layer. Time-dependent blur may be increased when the proportion of the thickness is less than 10%, while the color density and ozone resistance may be decreased when the proportion exceeds 60%.

The method for adjusting the thickness of the portion containing the mordant may be arbitrarily selected, and may comprise, for example, either (1) forming a coating layer containing the fine particles and the water-soluble resin, followed by applying a mordant-containing solution; or (2) simultaneously applying an coating solution containing the fine particles and the water-soluble resin, and the mordant-containing solution. Otherwise, the inorganic fine particles, the water-soluble resin and the cross-linking agent may be added to the mordant-containing solution.

While polymer mordants having primary to tertiary amino groups or quaternary ammonium salt groups are favorably used as the cationic mordant, cationic non-polymer mordants may also be used.

The polymer mordant is preferably obtained as a homopolymer of a monomer (mordant monomer) having primary to tertiary amino groups or salts thereof, or quaternary ammonium salt groups; or a copolymer or condensed polymer of the mordant monomer and other monomers (hereinafter referred to as “non-mordant monomer”). These polymer mordant can be used in the form of a water-soluble polymer or water dispersible latex particles.

Allylamine or diallyl amine, or derivatives or salts thereof may be also used. Examples of such compound include allylamine, allylamine hydrochloride, allylamine acetate, allylamine sulfate, diallylamine, diallylamine hydrochloride, diallylamine acetate, diallylamine sulfate, diallylmethylamine and salts thereof (e.g., hydrochloride, acetate and sulfate), diallylethylamine and salts thereof (e.g., hydrochloride, acetate and sulfate), and dialyldimethylammonium salts (with counter-ions such as chloride, acetate ion and sulfate ion). Since these allylamine and diallylamine derivatives are low in polymerizing ability in their free amine form, they are usually polymerized as salts followed by desalting, if necessary.

Using N-vinylacetamide or N-vinylformamide units, polymers are prepared and then converted into vinylamine units by hydrolysis after polymerization, and salts thereof may be also used.

The non-mordant monomer described above refers to a monomer that does not contain a basic or cationic moiety of the primary to tertiary amines and salts thereof, or quaternary ammonium groups, and the non-mordant monomer exhibits no interaction, or substantially small interaction if any, with the dye in the ink-jet ink.

When a phenolic compound is contained in the colorant-receiving layer of the invention, an organic acid or inorganic acid may be incorporated in the layer. The acid may be previously mixed with the phenolic compound, or may be mixed by simultaneously or arbitrarily applying a coating solution containing the phenolic compound.

The surface of the colorant-receiving layer is adjusted to pH of 3 to 8, preferably pH of 5 to 7.5, by adding the acid to the layer, since such a pH adjustment imparts improved resistance against yellowish color change to white base portions. The surface pH is measured using method A of the surface pH measurement method prescribed by Japan Paper and Pulp Technology Association (J. TAPPI). The pH can be measured using a paper surface pH measuring set (trade name: type MPC, manufactured by KYORITSU CHEMICAL-CHECK Lab., Corp.) corresponding to method A.

(Other Ingredients)

The ink-jet recording medium of the invention can contain other known additives such as an ultraviolet absorber, antioxidant, fluorescent brightening agent, monomers, polymerization initiator, polymerization inhibitor, blurring inhibitor, preservative, viscosity stabilizer, defoamer, surfactant, destaticizing agent, matting agent, curl preventive agent and waterproof agent, if necessary.

Other ingredients may be used alone or in combination two or more thereof. Other ingredients may be added by being dissolved in water, dispersion, dispersion in polymer, emulsification or forming into oil droplets, or may be encapsulated in micro-capsules. The adding amount of other ingredients is preferably in the range of 0.01 to 10 g/m².

The surface of the inorganic fine particles may be treated with a silane coupling agent for improving dispersibility of the inorganic fine particles. The silane coupling agent preferably has organic functional groups (such as vinyl, amino, epoxy, mercapto, chloro, alkyl, phenyl and ester groups) in addition to the moiety involved in such a coupling treatment.

In the invention, the coating solution for the colorant-receiving layer preferably contains a surfactant. Any surfactants, such as cationic, anionic, nonionic, amphoteric, fluorine-type and silicon-type surfactants may be used.

<Preparation of Ink-Jet Recording Medium>

The colorant-receiving layer of the ink-jet recording medium of the invention is preferably provided by forming a coating layer by applying, on the surface of the support, a coating solution containing the fine particles and the water-soluble resin, followed by adding a cross-linking agent in the coating solution and/or basic solution described below (wet-on-wet method). The coating layer is hardened by applying the basic solution with a pH of 8 or more by (1) simultaneously with forming the coating layer by applying the coating solution; or (2) during the drying step of the coating layer formed by applying the coating solution and before the coating layer exhibits a given falling rate period of drying. The cross-linking solution capable of cross-linking the water-soluble resin is preferably added to at least one or both of the coating solution and the basic solution. Providing the colorant-receiving layer hardened by cross-linking is preferable to improve ink absorbing property and prevent cracks of the layer.

The mordant is incorporated in the layer so that the thickness at the mordant-containing portion from the surface of the receiving layer accounts for 10 to 60% of the thickness of the total receiving layer. The mordant-containing portion is formed, for example, by any of the following method comprising (1) forming the coating layer containing the fine particles, the water-soluble resin and the cross-linking agent, followed by applying a mordant-containing solution onto the resultant coating layer; and (2) simultaneously applying an coating solution containing the fine particles and the water-soluble resin, and the mordant-containing solution. The inorganic fine particles, the water-soluble resin and the cross-linking agent may be contained in the mordant-containing solution.

The foregoing method for forming the mordant-containing layer is preferable since the ink-jet colorant can be sufficiently fixed by the action of the mordant, that is mainly distributed at a given portion of the colorant-receiving layer, to thereby improve color density, time-dependent blur, brightness of printed parts, water resistance of characters and images after printing, and ozone resistance. While a part of the mordant may be included in a layer initially provided on the support, the mordant applied afterward may be the same as or different from the first mordant.

The coating solution (coating solution A) for the colorant-receiving layer containing the fine particles (e.g., vapor phase silica) and water-soluble resin (e.g., polyvinyl alcohol) is prepared in the following manner.

The coating solution is prepared by adding the fine particles such as vapor phase silica and a dispersing agent to water (for example, at a silica fine particle concentration of 10 to 20% by mass in water), dispersing the fine particles using a high speed rotational wet-type colloid mill (trade name: Clearmix, manufactured by M technique Co., Ltd.) at a high speed rotation of 10,000 rpm (preferably, at 5,000 to 20,000 rpm) for 20 minutes (preferably, for 10 to 30 minutes), adding an aqueous polyvinyl alcohol (PVA) solution (to make the PVA concentration become about ⅓ of the concentration of the vapor phase silica), and dispersing by the same condition as described above. Preferably, the pH of the solution is adjusted to about pH of 9.2 with an aqueous ammonia, or a dispersing agent is used for stabilizing the coating solution. The thus obtained coating solution is in the state of a sol, and a porous colorant-receiving layer having a three-dimensional network structure is formed by applying the solution onto the support, followed by drying.

Dispersing machines used for obtaining the aqueous dispersion solution include various known dispersing machines such as a high speed rotational dispersing machine, medium agitating-type dispersing machine (such as a ball mill and a sand mill), ultrasonic dispersing machine, colloid mill dispersing machine and high pressure dispersing machine. However, the medium agitating-type dispersing machine, colloid mill dispersing machine and high pressure dispersing machine are preferable for efficiently dispersing coagulates of the fine particles.

Water, organic solvents and mixed solvents thereof may be used as the solvent in each step. Examples of the organic solvent used for preparing a coating solution include alcohols such as methanol, ethanol, n-propanol, i-propanol and methoxypropanol, ketones such as acetone and methylethyl ketone, tetrahydrofuran, acetonitrile, ethyl acetate and toluene.

Cationic polymers may be used as the dispersing agent. Examples of the cationic polymer include those described as the mordant. A silane coupling agent is also used as the dispersing agent.

The proportion of the dispersing agent added to the fine particles is preferably 0.1 to 30%, and more preferably 1 to 10%.

The coating solution of the colorant-receiving layer can be applied by a known method using an extrusion die coater, an air doctor coater, a blade coater, a rod coater, a knife coater, a squeeze coater, a reverse roll coater, and a bar coater.

While the basic solution (coating solution B) is applied on the coating layer simultaneously with or after applying the coating solution (coating solution A) for the colorant-receiving layer, coating solution B may be applied before the coating layer after the application to exhibit a falling rate period of drying. In other words, the colorant-receiving layer is favorably formed by providing coating solution B before the coating layer exhibits a falling rate period of drying after applying the coating solution (coating solution A) for the colorant-receiving layer. The mordant may be added to coating solution B.

The phrase “before the coating layer exhibits a falling rate period of drying” usually means a process within several minutes from immediately after applying the coating solution of the colorant-receiving layer. The content of the solvent (dispersing medium) in the applied coating solution decreases in proportion to the lapse of time (a constant rate period of drying). The time lapse exhibiting “constant rate period of drying” is described, for example, in Kagaku Kogaku Binran (Chemical Engineering Handbook), pp.707-712, Maruzen Co. Ltd., 25 October, 1980.

While the coating layer is dried until it exhibits a falling rate period of drying after applying coating solution A, the drying process is usually performed at 40 to 180° C. for 0.5 to 10 minutes (preferably, 0.5 to 5 minutes). While the drying time is different depending on the amount of coating, the aforementioned range is usually appropriate.

Examples of the method for applying the coating solution before the first coating layer exhibits a falling rate period of drying include (1) further applying coating solution B on the coating layer, (2) spraying coating solution B, and (3) dipping the support on which the coating layer has been disposed in coating solution B.

The method used for applying coating solution B in the above method (1) includes known application method using, for example, a curtain flow coater, an extrusion die coater, an air doctor coater, a blade coater, a rod coater, a knife coater, a squeeze coater, a reverse roll coater and a bar coater. The extrusion die coater, curtain flow coater or bar coater is preferably used to prevent the coater from contacting with the already formed first coating layer.

The coating layer is normally dried and hardened after applying coating solution B by heating at 40 to 180° C. for 0.5 to 30 minutes. Heating at 40 to 150° C. for 1 to 20 minutes is particularly preferable.

When the basic solution (coating solution B) is applied simultaneously with applying the coating solution (coating solution B) for the colorant-receiving layer, coating solutions A and B are simultaneously provided on the support so that coating solution A contacts the support (multi-layer coating), and then the solutions are dried to thereby form the colorant-receiving layer.

Coating methods using, for example, an extrusion die coater or a curtain flow coater may be employed for the simultaneous application (multilayer coating). While the coated layers are dried after the simultaneous coating, these layers are usually dried by heating at 40 to 150° C. for 0.5 to 10 minutes, and preferably by heating at 40 to 100° C. for 0.5 to 5 minutes.

When the coating solutions are simultaneously applied (multi-layer coating) using, for example, the extrusion die coater, the simultaneously supplied two coating solutions are laminated at near the outlet of the extrusion die coater, or immediately before the solutions are transferred onto the support, and are laminated on the support to make a dual layer. Since the two layers of the coating solutions laminated before application tend to cause cross-linking at the interface between the two solutions when the solutions are transferred onto the support, the supplied two solutions readily become viscous by being mixed with each other in the vicinity of an outlet of the extrusion die coater, occasionally leading to troubles in the coating operation. Accordingly, it is preferable to simultaneously arrange triple layers by presenting a barrier layer solution (intermediate layer solution) between the solution A and solution B simultaneously with applying of the coating solutions A and B.

The barrier layer solution may be selected without any restrictions. For example, the solution may be an aqueous solution containing a small amount of the water-soluble resin, or water. Since the water-soluble resin is used for increasing viscosity by in consideration of applicability of the solution, examples of the resin include cellulose-type resins (such as hydroxypropyl cellulose, methyl cellulose and hydroxyethylmethyl cellulose), polyvinyl pyrrolidone and gelatin. The mordant may be incorporated in the barrier layer solution.

The colorant-receiving layer may be subjected to a calender treatment by allowing the layer to pass through nip-rolls under a pressure with heating using, for example, a super calender and cross calender for improving surface smoothness, luster, transparency and coating layer strength. However, since the calender treatment may decrease the void ratio (or decrease ink-absorbing property), the calendering conditions should be adjusted to avoid a decrease in the void ratio.

The roll temperature for carrying out the calender treatment is preferably 30 to 150° C., and more preferably 40 to 100° C.

The linear pressure between the rolls for performing the calender treatment is preferably 50 to 400 kg/cm, and more preferably 100 to 200 kg/cm.

The thickness of the colorant-receiving layer should be selected in view of the void ratio in the layer for ink-jet recording, since the layer is required to exhibit an absorption capacity of absorbing all the ink droplets. For example, a thickness of about 15 μm or more is necessary when the amount of the ink applied is 8 nL/mm² and the void ratio is 60%.

The thickness of the colorant-receiving layer is preferably 10 to 50 μm for ink-jet recording, considering the foregoing conditions.

The pore diameter of the colorant-receiving layer is preferably 0.005 to 0.030 μm, and more preferably 0.01 to 0.025 μm, in terms of a radian diameter.

The void ratio and the radian diameter of the pores are measured using a mercury porosimeter (trade name: Pore Sizer 9320-PC2, manufactured by Shimadzu Corp.).

Since the colorant-receiving layer preferably has excellent transparency, the haze value indicative of transparency is preferably 30% or less, and more preferably 20% or less, when the colorant-receiving layer is formed on a transparent film substrate.

The haze value is measured using a haze meter (trade name: HGM-2DP, manufactured by Suga Test Instrument Co., Ltd.).

A polymer fine particles may be incorporated in the constituting layer (the colorant-receiving layer or the back-coat layer) of the ink-jet recording medium of the invention. The polymer fine particle dispersion is used to improve the layer characteristics such as dimensional stability, curl preventive effect, adhesion preventive effect and crack preventive effect of the layer. The polymer fine particle dispersion is described in JP-A Nos. 62-245258, 62-1316648 and 62-110066. The layer can be prevented from cracks and curling if the polymer fine particles having a low glass transition temperature (40° C. or less) are incorporated in the layer containing the mordant. The effect for preventing curling may also be augmented by adding the polymer fine particle dispersion having a high glass transition temperature to the back-coat layer.

### EXAMPLES

While the present invention is described in detail with reference to examples, the invention is by no means restricted to these examples. In these examples, “parts” and “%” are all by mass, unless otherwise indicated, and “degree of polymerization” means “weight average degree of polymerization”.

### Example 1

(Preparation of Support E)

A paper material prepared by adjusting LBKP comprising Acacia mangium to a Canadian freeness of 300 ml was blended with a paper material prepared by adjusting LBKP comprising aspen to a Canadian freeness of 300 ml in a mass ratio of 50:50.

To the pulp slurry obtained above was added 1.3% of cationic starch (trade name: CATO 304L, manufactured by Nihon NCS), 0.145% of anionic polyacrylamide (trade name: Polyacron ST-13, manufactured by Seiko Chemical Co.), 0.285% of alkylketene dimer (trade name: SizePain K, manufactured by Arakawa Chemical Co.), 0.8% of epoxydated behenic acid amide, and 0.295% of polyamide polyamine epichlorohydrin, followed by addition of a 0.1% defoamer.

The pulp slurry prepared as above was formed into a sheet of paper using a Fourdrinier paper machine, and dried with pressing the photographic emulsion coating face of the web against a drum drier cylinder via a drier canvas. Then, acrylic latex (trade name: Johncryl 538, manufactured by Johnson Polymer Co.; Tg=66° C.) was applied as an undercoat layer onto the paper substrate at the side provided with the colorant-receiving layer at a solid content of 4 g/m² using a blade coater. After drying and subjected to a calender treatment, support E having a basis weight of 178 g/m² and a thickness of 171 μm was prepared.

(Preparation of Back-coat Layer Coating Solution C)

A dispersion having a mica concentration of 5% was obtained by adding water to water-swellable fluorine-type synthetic mica (trade name: Somasiph MEB, manufactured by CO—OP Chemical Co.; aspect ratio=1000, average particle diameter (major axis length)=2.0 μm, a 8% aqueous solution). The obtained dispersion (40 parts) was added to 100 parts of a 10% aqueous solution of acetoacetyl-modified polyvinyl alcohol (trade name: Gosefinemer Z-100, manufactured by Nippon Synthetic Chemical Industry Co.), and then stirred for 30 minutes. To the resultant solution was added a 0.5 part of 2,3-hydroxy-5-methyl-1,4-dioxane as a hardening agent immediately before application, to thereby yield back-coat layer coating solution C.

(Preparation of Coating Solution A for Colorant-Receiving Layer)

A mixture of (1) vapor phase silica fine particles, (2) ion-exchanged water and (3) PAS-M-1 was dispersed at a rotational speed of 10,000 rpm for 20 minutes using KD-P (trade name, manufactured by Shinmaru Enterprises Co.). To the resultant dispersion was added a solution containing (4) polyvinyl alcohol, (5) boric acid, (6) polyoxyethylene lauryl ether, and (7) ion exchanged water, followed by additional dispersing operation at a rotational speed of 10,000 rpm for 20 minutes, to thus prepare coating solution A for the colorant-receiving layer.

The mass ratio (PB ratio=(1):(4)) of the silica fine particles to water-soluble resin was 4.5:1, and coating solution A for the colorant-receiving layer had an acidic pH of 3.5.

<Composition of Coating Solution A for Colorant-Receiving Layer>

| | | |
|---|---|---|
| (1) | vapor phase silica fine particles (inorganic fine particles) | 10.0 parts |
| | (measured with Rheoloseal QS 30, trade name, | |
| | manufactured by Tokuyama Co.; average primary | |
| | particle diameter 7 μm) | |
| (2) | ion-exchanged water | 51.7 parts |
| (3) | PAS-M-1 (60% aqueous solution) | 0.83 parts |
| | (dispersing agent, manufactured by Nittobo Co.) | |
| (4) | polyvinyl alcohol (water-soluble resin) (8% aqueous | 27.8 parts |
| | solution) (trade name: PVA 124, manufactured by | |
| | Kuraray Co.; degree of saponification 98.5%, | |
| | degree of polymerization 2,400) | |
| (5) | boric acid (cross-linking agent) | 0.4 parts |
| (6) | polyoxyethylene lauryl ether (surfactant) | 1.2 parts |
| | (trade name: Emulgen 109P, manufactured by Kao Co.; | |
| | 10% aqueous solution, HLB value 13.6) | |
| (7) | ion-exchanged water | 33.0 parts |

(Production of Ink-Jet Recording Sheet: Medium)

The top face (the surface coated with an acrylic latex as an undercoat layer) of support E was subjected to corona discharge treatment. Then, coating solution A for the colorant-receiving layer was applied at a coating amount of 170 ml/m² onto the top face using an extrusion die coater (coating step), and the layer was dried at 80° C. in a hot-air dryer (blow speed 3 to 8 m/sec) until the concentration of the solid content became 20%. The coating layer showed a constant rate period of drying during the drying step. After dipped in mordant solution B having the following composition to provide thereon a density of 16 g/m² for 30 seconds (mordant solution applying step), the layer was further dried at 80° C. for 10 minutes (drying step). Subsequently, back-coat layer coating solution C was applied onto the back face of the support E (the surface opposite to the surface coated with the acrylic latex as an undercoat layer) using an air knife coater such that the coating amount became 6 g/m² in terms of solids content to thereby dispose a back-coat layer after drying. As a result, an ink-jet recording sheet of Example 1 having a colorant-receiving layer with a layer thickness of 32 μm was produced.

<Composition of Mordant Solution B>

| | | |
|---|---|---|
| (1) | boric acid (cross-linking agent) | 0.65 parts |
| (2) | polyallylamine (trade name: PAA-10C) | 25 parts |
| | (10% aqueous solution) (mordant, | |
| | manufactured by Nittobo Co) | |
| (3) | 2-methyl piperazine | 2.0 parts |
| (4) | ion-exchanged water | 60.2 parts |
| (5) | ammonium chloride (surface pH control agent) | 0.8 parts |
| (6) | polyoxyethylene lauryl ether (surfactant) | 10 parts |
| | (trade name: Emulgen 109P, manufactured by Kao Co.; | |
| | 2% aqueous solution, HLB = 13.6) | |
| (7) | Megaface F1405 (10% aqueous solution) (trade | 2.0 parts |
| | name of fluorine-type surfactant, manufactured by | |
| | Dainippon Ink & Chemicals Inc.) | |

### Example 2

The ink-jet recording sheet of Example 2 was produced in a similar manner to Example 1, except that back-coat layer coating solution C′ described below was used in place of the back-coat layer coating solution C.

(Back-Coat Layer Coating Solution Cl

A dispersion of water-swellable fluorine-type synthetic mica (with an average particle diameter of 0.5 μm and an aspect ratio of 250) was obtained by pulverizing the dispersion of water-swellable fluorine-type synthetic mica (trade name: Somasiph MEB, manufactured by CO—OP Chemical Co.; aspect ratio=1000, average particle diameter=2.0 μm, 8% aqueous solution) used in preparing the colorant-receiving layer coating solution via a KDL-PILOT dyno-mill (trade name, manufactured by Shinmaru Enterprises Co.). Water was added to the obtained dispersion to give a mica concentration of 5%. The resulting solution (40 parts) was added to 100 parts of a 10% aqueous solution of acetoacetyl-modified polyvinyl alcohol (trade name: Gosefinemer Z-100, manufactured by Nippon Synthetic Chemical Industry Co.), and then stirred for 30 minutes. To the resultant solution was added 0.5 part of 2,3-hydroxy-5-methyl-1,4-dioxane as a hardening agent immediately before application, to thereby afford back-coat layer coating solution C′.

### Example 3

(Production of Ink-Jet Recording Sheet)

After subjecting the top surface of support E to corona discharge treatment, back-coat coating solution C was applied using an air knife coater such that the solid content became 6 g/m², and the undercoat layer was formed after drying. Coating solution A for the colorant-receiving layer obtained as above was applied onto the undercoat layer, at the top face of the support, using an extrusion die coater at an amount of coating of 170 ml/m² (coating step). The layer was dried by means of a hot-air drier at 80° C. (blow speed 3 to 8 m/sec) until the concentration of the solid content of the coating layer became 20%. The coating layer showed a constant rate period of drying during the drying process. The layer was immediately dipped in mordant solution B having the following composition for 30 seconds to provide the mordant solution to the coating layer at a density of 16 g/m² (mordant solution coating step), followed by drying at 80° C. for 10 minutes (drying step). The ink-jet recording sheet of Example 3 having the colorant-receiving layer with a dry thickness of 32 μm was thus obtained.

### Comparative Example 1

The ink-jet recording sheet of Comparative Example 1 was prepared in a similar manner to Example 1, except that the following back-coat layer coating solution D was used in place of the back-coat layer coating solution C.

(Preparation of Back-Coat Layer Coating Solution D)

Back-coat layer coating solution D was obtained by adding 100 parts of Planar zeeklite (trade name: zeeklite TMC, manufactured by Zeeklite Co.; aspect ratio 5 to 90, average particle diameter 2 to 3 μm) to 200 parts of a 10% aqueous solution of polyvinyl alcohol (trade name: PVA-117, manufactured by Kuraray Co.) with stirring.

### Comparative Example 2

An ink-jet recording sheet of Comparative Example 2 was produced in a similar manner to Example 1, except that the following support F was used in place of support E, and back-coat coating solution C was not applied.

(Preparation of Support F)

Polyethylene having density of 0.980 g/m² was coated on the back surface of support E to give a thickness of 25 μm using a melt-extruder. Separately, polyethylene having density of 0.960 g/m² and containing 10% of titanium oxide was coated on the top surface of the obtained support with a thickness of 25 μm, to thereby prepare support F.

Evaluation Tests

The inkjet recording sheets of Examples 1 to 3 and Comparative Examples 1 and 2 were evaluated for the following properties. The results are shown in Table 1.

(1) Time-Dependent Blurring of Ink

A linear lattice pattern (line width: 0.28 mm) comprising magenta ink lines adjacent to black ink lines was printed on respective ink-jet recording sheets using an ink-jet printer (trade name: PM-900C, manufactured by Seiko Epson Co.). Immediately after printing, each printed ink-jet recording sheet was inserted into a transparent propylene filing bag, and stored in an environment at a temperature of 35° C. and relative humidity (RH) of 80% for 3 days. Then, the width A of the black line of the linear pattern was measured to calculate the time-dependent blurring of the ink (%) from the obtained width A of the black line and the width B of the back line that had been separately measured immediately after printing.

Time-dependent blurring of ink (%)=(A/B)×100

(2) Image Quality After Printing

A photographic image was printed on respective ink-jet recording sheets using an ink-jet printer (trade name: PM-900, manufactured by Seiko Epson Co.). Immediately after printing, each printed ink-jet recording sheet was inserted into a transparent propylene filing bag, and stored for 1 month. Image qualities were evaluated visually after the storage according to the following criteria.

⊚: The image quality after printing is quite excellent;

◯: The image quality after printing is good;

Δ: The image quality after printing is slightly poor (slight blurring and irregular printing); and

X: The image quality after printing is poor (blurring and irregular printing found).

(3) Cracks at the Surface of the Colorant-Receiving Layer

The surface of the colorant-receiving layer of each ink-jet recording sheet was examine with a microscope to evaluate for cracks of the colorant-receiving layer according to the following criteria.

⊚: good with no cracks at all;

◯: while minute cracks were partially found, the cracks did not seriously affect quality of the printed image;

Δ: fine cracks are observed on an entire surface; and

X: large cracks are observed on an entire surface.

(4) Irregular Printing

A solid image of the black ink was printed on each ink-jet printing sheet using an ink-jet printer (trade name: PM-900, manufactured by Seiko Epson Co.). Irregular printing at the solid print portion was evaluated visually according to the following criteria.

⊚: good printing with no irregularity at all;

◯: while minute irregular printing was partially observed, the irregularity did not largely affect quality of the printed image;

Δ: relatively large irregular printing was partially observed; and

X: irregular printing appeared on an entire surface with poor printed image.

(5) Curl

A solid image of the black ink was printed on respective ink-jet printing sheets using an ink-jet printer (trade name: PM-900, manufactured by Seiko Epson Co.) in an environment at a temperature of 23° C. and relative humidity (RH) of 65%. The printed sheet was cut into A4 size (210 mm×297 mm), and the pieces were placed in the environments of a temperature of 10° C. and a relative humidity RH of 20%, a temperature of 23° C. and a relative humidity RH of 65%, and a temperature of 30° C. and a relative humidity RH of 80%, respectively. The pieces were measured for a height at four corners to assess the degree of curling from the average value of the height obtained.

TABLE 1

| | Time- | | Cracks at the | | | | |
|---|---|---|---|---|---|---|---|
| | Dependent | | Surface of Color | | Curling (mm) after Printing | | |
| | Blurring of Ink | Image Quality | Material Receiving | Irregular | 10° C. | 23° C. | 30° C. |
| | (%) | After Printing | layer | Printing | 25% RH | 65% RH | 80% RH |
| Example 1 | 114 | ⊚ | ◯ | ◯ | 4 | 2 | 0 |
| Example 2 | 118 | ◯ | ◯ | ◯ | 6 | 3 | 0 |
| Example 3 | 112 | ⊚ | ⊚ | ◯ | 8 | 6 | 4 |
| Comparative | | | | | | | |
| Example 1 | 121 | ◯ | X | X | 15 | 4 | −4 |
| Comparative | | | | | | | |
| Example 2 | 164 | X | ◯ | ◯ | 5 | 3 | 1 |

The results summarized in Table 1 reveal that the ink-jet recording sheets of the invention show little blurring of the ink, no cracks are found at the surface of the colorant-receiving layer, no irregular printing is observed, to thereby indicate excellent image quality in the samples stored for a given period of time. In addition, the ink-jet recording sheets of the invention exhibit good curling property in a broad temperature range.

As detailed above, the present invention provides an ink-jet recording medium capable of high image quality recording by suppressing curling of recording sheets in a broad temperature and humidity range, by suppressing a surface of a colorant-receiving layer from cracking, and by suppressing irregular printing from being generated.

What is claimed is:

1. An ink-jet recording medium comprising a support having disposed thereon at least one colorant-receiving layer,
wherein an undercoat layer containing an inorganic laminar compound having an aspect ratio of 100 or more is provided under the colorant-receiving layer, and/or a back-coat layer containing an inorganic laminar compound having an aspect ratio of 100 or more is provided on a surface opposite to a surface of the support having the colorant-receiving layer.

2. The ink-jet recording medium according to claim 1, wherein the support includes a paper substrate, and a surface of the paper substrate at a side having the colorant-receiving layer has an ink solvent-absorbing property.

3. The ink-jet recording medium according to claim 2, wherein the paper substrate contains an acacia kraft pulp.

4. The ink-jet recording medium according to claim 1, wherein the laminar compound is water-swellable synthetic mica.

5. The ink-jet recording medium according to claim 1, wherein the undercoat layer and/or the back-coat layer contains a water-soluble resin.

6. The ink-jet recording medium according to claim 5, wherein the water-soluble resin is a polyvinyl alcohol-type resin and/or gelatin.

7. The ink-jet recording medium according to claim 1, wherein the colorant-receiving layer contains a water-soluble resin.

8. The ink-jet recording medium according to claim 7, wherein the water-soluble resin contained in the colorant-receiving layer is at least one selected from the group consisting of a polyvinyl alcohol-type resin, a cellulose-type resin, an ether bond-containing resin, a carbamoyl group-containing resin, a carboxyl group-containing resin, and gelatin.

9. The ink-jet recording medium according to claim 1, wherein the colorant-receiving layer contains fine particles.

10. The ink-jet recording medium according to claim 9, wherein the fine particles are at least one kind of particles selected from the group consisting of silica fine particles, colloidal silica, alumina fine particles and pseudo-boehmite.

11. The ink-jet recording medium according to claim 5, wherein the colorant-receiving layer contains 1 to 40% by mass of the water-soluble resin relative to a total solid content of the colorant-receiving layer.

12. The ink-jet recording medium according to claim 1, wherein the back-coat layer contains any one selected from the group consisting of a pigment, a metal soap, a wax, and a waterproof agent.

13. The ink-jet recording medium according to claim 12, wherein the pigment is selected from the group consisting of kaolin, sintered kaolin, talc, agalmatolite, diatomaceous earth, calcium carbonate, aluminum hydroxide, magnesium hydroxide, zinc oxide, lithopone, amorphous silica, colloidal silica, sintered gypsum, silica, magnesium carbonate, titanium oxide, alumina, barium carbonate, barium sulfate, mica, micro-balloon, urea-formalin filler, polyester particles, and cellulose filler.

14. The ink-jet recording medium according to claim 12, wherein the metal soap is selected from the group consisting of zinc stearate, aluminum stearate, calcium stearate, and zinc oleate.

15. The ink-jet recording medium according to claim 12, wherein the wax is selected from the group consisting of paraffin wax, polyethylene wax, carnauba wax, microcrystalline wax, candelilla wax, montan wax, and fatty acid amide wax.

16. The ink-jet recording medium according to claim 1, wherein the back-coat layer has a thickness of 0.2 to 20 μm.

17. The ink-jet recording medium according to claim 1, wherein the support has a thickness in terms of basis weight of 50 to 250 g/m².

18. The ink-jet recording medium according to claim 5, wherein the colorant-receiving layer contains 50% by mass or more of the fine particles relative to a total solid content of the colorant-receiving layer.

19. The ink-jet recording medium according to claim 1, wherein the colorant-receiving layer contains at least one mordant selected from polyallylamine and the derivatives thereof, and polyvinylamine and the derivatives thereof.

20. The ink-jet recording medium according to claim 1, further comprising an additive selected from the group consisting of an ultraviolet absorber, antioxidant, fluorescent brightening agent, monomers, polymerization initiator, polymerization inhibitor, blurring inhibitor, preservative, viscosity stabilizer, defoamer, surfactant, destaticizing agent, matting agent, curl preventive agent, and waterproof agent.
